(19) United States
(12) Patent Application Publication
(10) Pub. No.: US 2004/0172303 A1
(43) Pub. Date: Sep. 2, 2004

(54) System for controlling medical data acquisition processes

(75) Inventors: Jerome Marie Joseph Declerck, Oxford (GB); Christian Peter Behrenbruch, Oxford (GB); John Michael Brady, Oxford (GB)

Correspondence Address: KALOW & SPRINGUT LLP, 488 MADISON AVENUE, 19TH FLOOR, NEW YORK, NY, 10022, US

(73) Assignee: Mirada Solutions, Ltd., Oxford (GB)

(21) Appl. No.: 10/757,857

(22) Filed: Jan. 14, 2004

(30) Foreign Application Priority Data
Jan. 15, 2003 (GB) GB 0300922.2

(51) Int. Cl. G06F 17/60

(52) U.S. Cl. 705/2

(57) ABSTRACT

A system for controlling medical data acquisition, such as imaging, comprises a supervisory protocol controller which controls in real time a data acquisition device, such as an imaging apparatus, and an agent administration controller, such as a drug delivery device for delivering contrast agent. The supervisory protocol controller receives data from the acquisition apparatus and controls the acquisition apparatus and the administration controller based on that acquired data. Thus the acquisition protocol can be controlled and changed in response to the actual acquisition circumstances.

### BACKGROUND OF THE INVENTION

The present invention relates to a system for controlling the acquisition of medical data, in particular to provide for the possibility of improved medical data acquisition protocols.

The acquisition of medical data such as image or spectroscopy data is an important part of modern medical practice. As diagnostic imaging (medical imaging) with technologies such as Magnetic Resonance Imaging (MRI), Computed Tomography (CT) and Positron Emission Tomography (PET) increase in spatial resolution, acquisition speed and clinical flexibility, sophisticated diagnostic techniques involving the injection of imaging agents to characterise very specific physiological and pathophysiological indicators have evolved. This concept extends from very basic contrast agents (for example, iodine blood pool agents that increase the x-ray attenuation of a CT scan and hence improve the contrast blood vessels) to the new fields known as “molecular imaging” and “functional imaging”.

Molecular imaging (MI) and functional imaging (FI) are revolutionary because imaging agents can be used which target very specific biophysical, cellular or genetic behaviour. It is possible to screen for a specific disease by attaching a gene to an imaging agent that only makes the compound visible during medical imaging if a particular disease (e.g. oncogene) is present. This notion extends to a vast range of applications from oncology to cardiology and neuroimaging for diseases such as Parkinson's and Alzheimer's syndromes.

Given that molecular imaging (which can be broadly generalised to “functional imaging”) can accurately characterise a disease state, it can also accurately characterise treatment response to surgery, chemotherapy (including gene therapy, stem cell therapy) and radiotherapy. However in order to benefit fully from such functional imaging techniques it would be advantageous to achieve the control and measurement of delivery of the imaging agent. Even slight variations in the injection profile or inhalation of a highly sophisticated imaging agent can alter the measured value of the indicated [patho]phyisiology. This is important calibration information for the analysis of the imaging process.

### DISCUSSION OF PRIOR ART

Currently some devices exist to control and trigger drug delivery and image acquisition. This is illustrated in FIG. 1 of the accompanying drawings. A medical data acquisition device 1, in this case an imaging device, is operable to provide images of a subject 3, in this case a human patient. Dung the image acquisition process a drug delivery device 5 is used to administer a contrast agent to the patient and the drug delivery and image acquisition are synchronised in accordance with a predefined acquisition protocol under control of a computer-based control system 7. Conventionally the patient's condition may be monitored (such as blood pressure, ECG etc) by an additional patient monitoring device schematically illustrated as 9. A human operator of the system may abort the acquisition protocol if the patient monitoring device 9 shows an undesirable change in the patient's condition.

However, this conventional type of system can only put into practice a set, pre-defined acquisition protocol. The only way of adapting the protocol is in response to the human assessment of the patient's condition. With many acquisition techniques this can cause problems because the timing of the image acquisition should be responsive to the behaviour of the agent in the subject, rather than simply to the timing of the command to the drug delivery device.

Similar problems arise in other medical data acquisition techniques such as spectroscopy (e.g. magnetic resonance spectroscopy).

### SUMMARY OF ME INVENTION

According to the present invention there is provided a system for controlling medical data acquisition process, comprising a data acquisition apparatus controller for controlling data acquisition apparatus to acquire medical data from a subject;

an agent administration controller for controlling a device to administer an agent to the subject;

a medical data processor for receiving the medical data from the data acquisition apparatus and processing it;

a protocol controller for controlling the data acquisition apparatus controller and the agent administration controller in response to processed medical data results from the medical data processor.

Preferably the data is processed in “real time”, i.e. as it arrives, or within a short time compared to the timing of the whole procedure, so that “real time” control of the data acquisition apparatus based on the processed results is then possible.

Thus the present invention allows synchronisation of the agent administration (such as an imaging agent, e.g. contrast agent) with the results of the data acquisition itself (e.g. the image being acquired). This allows a much closer control of the acquisition protocol.

The device for administering the agent may be an automatic drug delivery device, and the agent may be a pharmaceutical agent, such as doubutamine for stress heart imaging, or an imaging agent, such as a contrast agent, in the case of medical imaging.

The protocol controller may control the relative timing of agent administration and data acquisition, may control the type and amount of agent administered so that, for example, more than one type of agent may be administered at different times through the protocol, and may control the data acquisition apparatus to switch between different data acquisition modes (for instance to collect different types of data at different times during the protocol).

The protocol controller may also be responsive to additional data acquired from the subject independently of the medical data acquisition apparatus. For example, in the case of a human or animal subject this may be in response to patient movement, blood pressure, heart rate variation etc. In particular, to successfully acquire medical images, particularly for moving organs, it is sometimes necessary to include physiological measurements of the patient, such as heart rate/characteristics, respiratory information, motion etc. In one specific case this could be as simple as recording head movement during an MR scan, which movement introduces artefacts in the image, which could be confused with disease. The protocol controller can, for example, suspend image acquisition temporarily during a period of patient movement, thus adapting the protocol in real time.

The system is applicable both to the acquisition of medical data in vivo, e.g. from a human, animal or plant subject, and in vitro, e.g. from medical samples. It is applicable to both dynamic studies, i.e. the use of medical imaging to characterise the physiological or pathophysiological behaviour as a function of time. Often this is performed in conjunction with an in vivo imaging agent which has specific biophysical or pharmacokinetic behaviour. The invention is also applicable to pharmacokinetics, i.e. the biophysical characterisation of a molecule, compound, gene etc in or from the body.

The invention allows the synchronisation of the agent delivery and data acquisition, including baseline acquisition and delays between the delivery of the agent, its delivery profile and the commencement of acquisition. Additionally, with knowledge (e.g. a model) of an agent's behaviour in the subject, it is possible to optimise the way in which the acquisition process is conducted with respect to the subject, for example in the case of a human or animal, in response to the height, weight, cardiac throughput of the subject, or the characteristics of the data acquisition apparatus itself. This can give a better managed acquisition, better image quality, an optimised tradeoff between spatial and temporal resolution and, in certain cases (for example, with CT) minimisation of radiation dosed to the patient.

Synchronisation of the analysis of the data acquisition with the agent delivery allows critical timing information to be obtained to optimise the information produced by the interaction between the agent and the physiological phenomenon under investigation. Further, real time analysis of the behaviour of the agent can be used to alter the acquisition sequence in order further to improve the acquisition result, reduce false positives, negatives, artefacts, and to calibrate the analysis of the agent against fluctuations in other measured parameters of subject, such as blood pressure, respiration rate etc in a human or animal.

### BRIEF DESCRIPTION OF THE DRAWINGS

The invention will be further described by way of example with reference to the accompanying drawings in which:

FIG. 1 illustrates a prior art medical data acquisition system;

FIG. 2 illustrates a medical data acquisition system in accordance with one embodiment of the present invention;

FIG. 3 illustrates the critical process timings in an image acquisition process for liver CT imaging in accordance with an embodiment of the present invention;

FIGS. 4(a) to (f) illustrate a frame sequence showing the change in intensity with time in a Gadolinium enhanced MRI scan; and

FIG. 5 illustrates the change in intensity of a given voxel over time in a typical Gadolinium enhanced MRI scan.

### DESCRIPTION OF ILLUSTRATIVE EMBODIMENTS

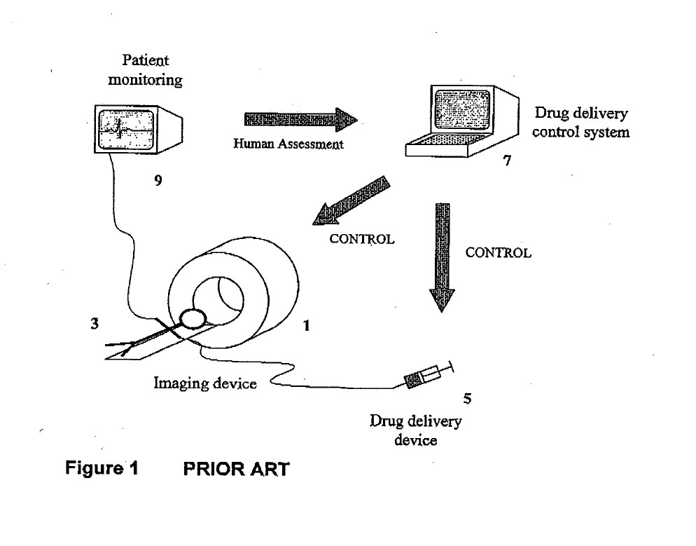

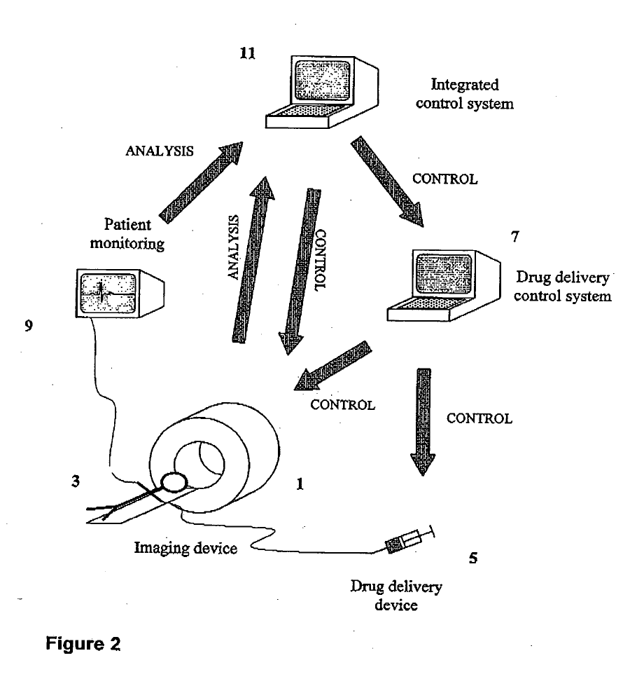

FIG. 2 illustrates a control system in accordance with the present invention applied to the imaging apparatus described above with reference to FIG. 1. The parts found in FIG. 1 are labelled with the same reference numerals and thus include the imaging device 1, the subject 2, the drug delivery device 5, the control system 7 and the additional patient monitor 9. In accordance with the present invention, though, the acquisition device 1 and agent administering device 5 are controlled, via the control system 7, by a supervisory control system 11. While this is shown separately from the control system 7 in FIG. 2, the two may be combined. The supervisory control system 11 receives data from the imaging device and also from the additional patient monitor 9 and controls the drug delivery device 5 and imaging device 1 in real time in response to this image data and additional data from the monitoring device 9. Thus the supervisory control device 9 connects the imaging agent (drug) delivery mechanism 5, the imaging process, the acquisition of physiological parameters from the patient via monitoring device 9 and the analysis of the behaviour of the imaging agent for the purposes of diagnosis It is illustrated in FIG. 2 as being embodied in a general purpose personal computer, i.e. as a single integrated software system, though it can be embodied as a distributed set of software tools across the control system 7, drug delivery device 5, imaging device 1 and patient monitor 9. The supervisory controller 11 is effective via the control system 7 to control both the relative timing of drug delivery and image acquisition, and the type of drug (e.g. contrast agent) delivered and the mode of data acquisition. Thus multiple imaging agents may be administered with a desired administration profile, and the imaging device may be controlled accordingly, possible to switch modes in accordance with the different agents administered.

Two different specific examples of the type of control made possible by the present invention will now be described.

1) CT Imaging of the Liver

Conventionally, liver tumours are assessed with CT images enhanced with contrast agents. The agent is used to create contrast between vascularisation and the tissue itself. The objective of the diagnostic based on such images is two-fold:

1) detection and assessment of liver tumours. Tumours are characterised by lower contrast compared to the surrounding healthy tissue when the contrast agent washes in through the portal vein. Some other imaging modality like PET can be used to differentiate cancerous tumours from cysts or necrosis and degeneration from cirrhotic diseases, for instance. The main use of the CT image is to determine the location and extent of the tumours.

2) visualisation of the vascularisation of great vessels for surgery planning. When surgery is planned for the resection of the tumours, great care must be taken to remove the minimum amount of liver. The clinician uses the vascularisation tree to determine the region to remove.

The selection of the resection region is a complex process: in clinical procedures, the liver is decomposed into 8 different segments, where boundaries are based on anatomical landmarks (Lafortune et al., “Segmental anatomy of the liver: a sonographic approach to the Couinaud nomenclature”:Radiology 181(2):443-448, 1991). Other approaches enhance the precision of the definition of these boundaries using the portal vein instead of external shape-based landmarks (L. Soler, H. Delingette, G. Malandain, J. Montagnat, N. Ayache, C. Koehl, O. Dourthe, B. Malassagne, M. Smith, D. Mutter and J. Marescaux: “Fully automatic anatomical, pathological, and functional segmentation from CT scans for hepatic surgery”, Computer Aided Surgery, vol. 6, num. 3, August 2001). Basing the segmentation of liver on vascular tree is absolutely key for surgery planning, as the vascularisation of the liver is one of the most complex of the whole human body. There are so many blood vessels that a cut must minimise bleeding. Cutting through a great vessel is simple, as bleeding is easily controlled with clamping. Cutting through capillaries is simple as well, as cauterisation stops bleeding. But cutting at random in the liver can cause the rupture of many intermediate sized vessels, which cannot be cauterised because they are too big, and for which clamping is not practical because hundreds of such vessels could be opened in one single cut.

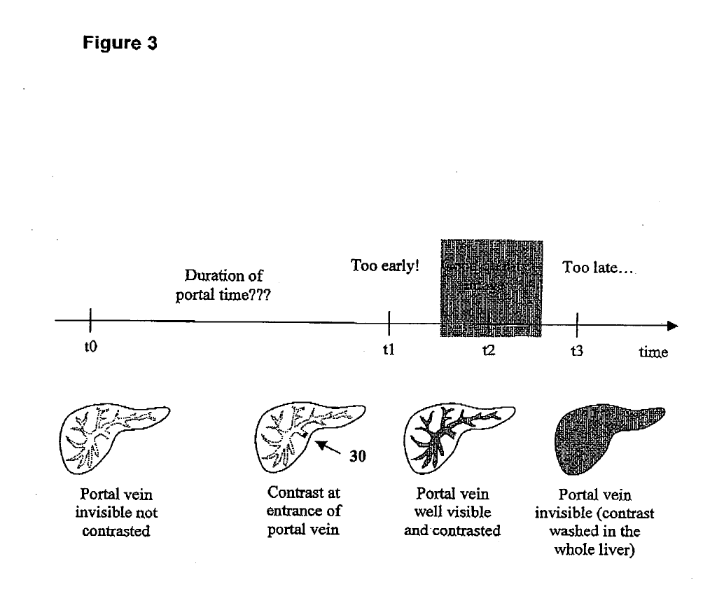

Identification of the segments based on vascularisation is a more and more clinically accepted practice, but it needs good vascular tree segmentation. Such segmentation can be obtained for instance using CT imaging as illustrated in FIG. 3. In a normal CT scan, the portal tree is not visible nor differentiable from surrounding liver cells, so the use of a contrast agent is necessary. Following a classic imaging protocol, the CT image is acquired very quickly after some contrast agent has been delivered into the patient's blood. The contrast agent is injected in a single bolus (t0), and after a small period of time (t1, which is called portal time), the bolus reaches the portal vein 30, one of the main vascular trees irrigating the liver. The contrast agent washes into the liver and enhances all vascular branches, until it reaches the capillaries (t2). Then, contrast agent washes in all cells and other artery trees before flowing out in the vena cava (t3). By this time, the whole liver is brightened by the contrast agent and the portal tree is no longer visible.

There are two main difficulties in the acquisition of a good and usable image:

1) The image needs to be acquired at t2, and not at t1 or t3. The problem is that the margin t3-t1 is very small, typically 5 or 10 seconds, so the image must be acquired very quickly.

2) The portal time needs to be estimated but cannot be determined a priori with accuracy. Usually, t1-t0 is between 10 and 20 seconds. If the portal time t1is not estimated correctly, the image is unusable, either too dark, or too bright, with no contrasting vascular tree.

So the evaluation of the exact portal time, i.e. time point t₁, is the key to triggering the start of the imaging procedure. With the present invention the protocol controller receives the data from the image acquisition apparatus and so is programmed to look for the arrival of contrast agent at the entrance 30 to the portal vein. On detection on the image of contrast agent at the portal vein the time point t1 is established with certainty. Thus rather than estimating the time for contrast agent to arrive from the drug delivery device to the portal vein (which could be about 20 seconds), its exact arrival at the entrance to the portal vein is detected. Then an image acquisition protocol for obtaining different slice images through the liver can be started to cover the short time period, for example 5 to 10 seconds, between times t1 and t3. Automatic detection of the arrival of the contrast agent at the portal vein is achieved, for example, by the clinician first determining the location of the entrance of the portal vein in a CT “scout” image used for setting a region of interest for the 3D image acquisition. The scanner then acquires at regular time intervals (e.g. every 2 or 3 seconds) an image of the area, and compares each image with the preceding one. The arrival of contrast agent shows up easily as a bright area on the previously uniformly grey vessel.

MR Imaging of the Breast

An example based on an optimised contrast-enhanced magnetic resonance image of the breast will now be described.

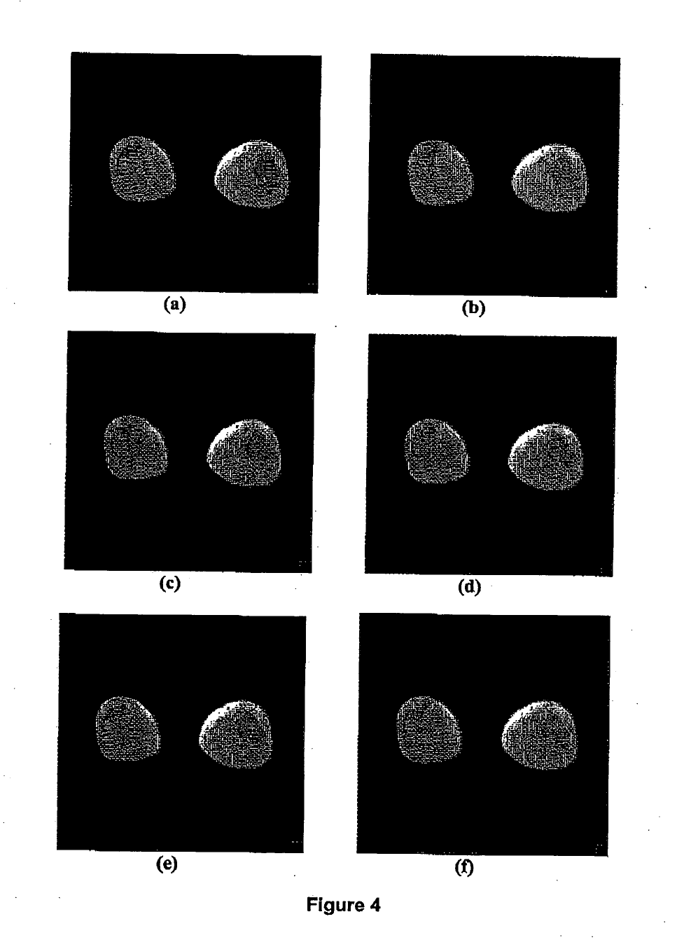

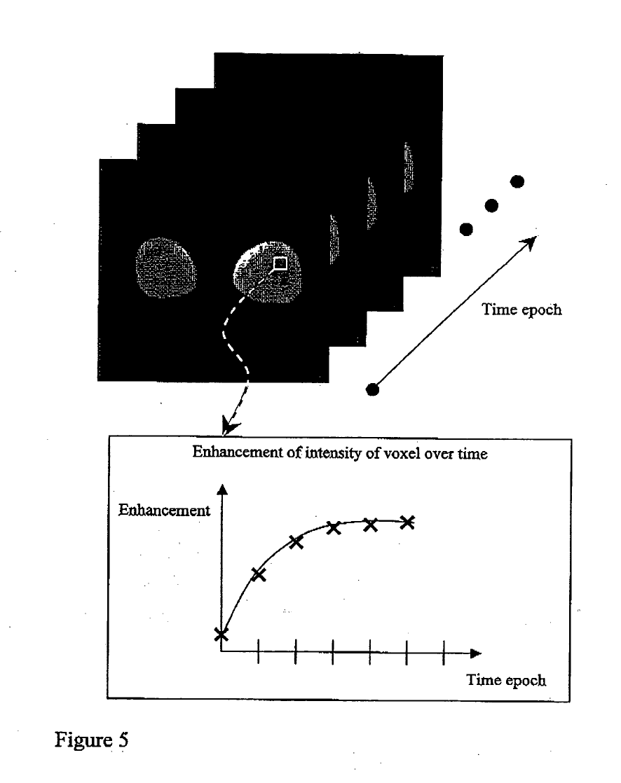

FIGS. 4 and 5 illustrate the typical dependency of contrast enhanced intensity against time using Gadolinium (Gd) as a contrast agent. FIG. 4 illustrates six frames of the sequence and FIG. 5 shows a graph of the intensity of a given voxel. It can be seen that the intensity arises quite steeply over the first one or two minutes, e.g. through images (a), (b) and (c), and then decays very gradually, little change ocurring from images (c) through (f). In order to accurately characterise the nature of the material being enhanced it is necessary to detect the shape of this curve as accurately as possible. In particular, for example, it is important to be able to detect the peak intensity. Rather than following an acquisition protocol based on estimated behaviour, which may be based on some particular tissue type (or some average) the present invention allows different image acquisition modalities to be used during different times in the protocol. For example:-

1) The supervisory control system 11 invokes a “baseline” (pre-injection) image acquisition along with calibration images for various physics-based corrections. For example, the paper Armitage P. A., Behrenbruch C. P., Brady, J. M. and Moore N. “Optimising flip-angles for improved T1 calculation in 3D contrast-enhanced breast MR imaging” in Proc. International Society of Magnetic Resonance in Medicine 2001 p. 526, describes a protocol to acquire images to compute a T1 map, which is characteristic of the tissue. (There are two reasons why a contrast agent shows a bright spot in MRI: (a) the T1 of the tissue is high, and becomes higher when the high-T1 contrast agent washes in, and (b) the tissue has an average T1, but there is a lot of contrast agent washing in. The difference is (a) is indicative of tissue that is definitely benign and normal, whereas (b) could be indicative of the trace of malignant tumour. Basically, when looking at the post-contrast image, there is no way to be able to quantitate how much of the brightening effect comes from the contrast agent and how much comes from the tissue. Obtaining a T1 map prior to the acquisition allows correction of the enhancement map for these artefacts.)

2) It then commands the delivery device 5 to inject Gadolinium (Gd) in a controlled bolus injection profile to be imaged in step (3) and characterised as an arterial input function in preparation for analysis.

3) The supervisory control system 11 immediately switches the MRI system 1 to a rapid echoplaner (EPI sequence) which performs a low spatial, high temporal resolution image (1 second acquisition) of the region of interest in the breast (or, in other examples, different parts of the body, e.g. the brain) until the measured contrast-induced (Gd) signal intensity in the imaging process reaches 100% of baseline. This period is critical for characterising regions of angiogenesis indicated by the uptake of gadolinium.

4) The supervisory control system 11 then switches the acquisition profile of the MRI system 1 to a slower, high-resolution gradient echo (e.g. Fast SPoiled GRadient echo pulse sequence—FSPGR) sequence that acquires high quality 3D volumes to measure the plateau of contrast agent behaviour. Simultaneously, a smaller steady infusion of Gd is added via the delivery device 5 to buffer the peak contrast.

5) A series of FSPGR sequences are acquired until the washout is sufficiently characterised to end acquisition. At the point where the analysis tools have all the phamacokinetic parameters needed, acquisition is ceased.

6) The user is presented with a finalised analysis of the MRI data showing accurately parameterised areas of uptake which statistically correspond to regions indicative of tumour angiogenesis. This result is optimised as the analysis tool was “in time” to detect different phases of the contrast agent's biophysical behaviour (including injection profile) which in turn controlled infusion of Gd and the acquisition protocol.

The invention can also accept data input from other sources, such as a heart rate monitor 9. Thus, for example, if midway through the acquisition the patient experiences some anxiety, as detected by an increase in cardiac activity, and moves, the supervisory protocol controller 11 can suspend acquisition, optionally motion correct to the new patient geometry (e.g. using the technique described in WO 00/57361 herein incorporated by reference) and continue with the acquisition process.

Although the invention has been described above with respect to specific imaging techniques, it is applicable to other imaging and data acquisition techniques including the use of: medical imaging by devices such as CT/MRI/PET/SPECT/X-ray/Ultrasound/Optical, functional imaging, dynamic imaging, imaging with radiopharmaceuticals, contrast agents, hyperpolarised gases, x-ray attenuation agents, genetic/oncogenic markers, cellular/receptor level indicators, blood pool/flow agents and combined targeted imaging agents/targeted therapy agents.

The invention may be embodied in a computer program which, when executed on a general purpose computer, controls the data acquisition and agent administering device. Alternatively it may be embodied in firmware, programmable logic or dedicated process controls and automation systems.

What is claimed is:

1. A system for controlling a medical data acquisition process, comprising a data acquisition apparatus controller for controlling data acquisition apparatus to acquire medical data from a subject;
an agent administration controller for controlling a device to administer an agent to the subject;
a medical data processor for receiving the medical data from the data acquisition apparatus and processing it;
a protocol controller for controlling the data acquisition apparatus controller
and the agent administration controller in response to processed medical data results from the medical data processor.

2. A system according to claim 1 wherein the device to administer an agent to the subject is an automatic drug delivery device.

3. A system according to claim 1 wherein the agent is a pharmaceutical agent.

4. A system according to claim 1 wherein the agent is an imaging agent, the data acquisition apparatus is an imaging apparatus and the medical data processor is an image processor.

5. A system according to claim 4 wherein the imaging agent is a contrast agent for selectively enhancing the contrast of at least one region of the subject.

6. A system according to claim 1 wherein the data acquisition apparatus is a spectroscopy apparatus and the medical data processor is a spectral data processor for processing data acquired by the spectroscopy apparatus.

7. A system according to claim 1 wherein the protocol controller controls the relative timing of data acquisition and agent administration, via the data acquisition apparatus controller and the agent administration controller respectively, in response to processed medical data results from the medical data processor.

8. A system according to claim 1 wherein the protocol controller controls the agent administration controller to control the amount of agent administered to the subject in response to processed medical data results from the medical data processor.

9. A system according to claim 1 wherein the protocol controller controls the agent administration controller to control the type of agent administered to the subject in response to processed medical data results from the medical data processor.

10. A system according to claim 1 wherein the protocol controller controls the data acquisition apparatus controller to control the mode of data acquisition to acquire data in at least two different modes in response to processed medical data results from the medical data processor.

11. A system according to claim 1 wherein the protocol controller is responsive to additional data acquired from the subject independently of the medical data acquisition apparatus.

12. A system according to claim 1 wherein the medical data is acquired in vivo from a human, animal or plant as said subject.

13. A system according to claim 1 wherein the medical data is acquired in vitro.
